(19) United States
(12) Patent Application Publication
(10) Pub. No.: US 2005/0193154 A1
(43) Pub. Date: Sep. 1, 2005

(54) Controller for peripheral communications with processing capacity for peripheral functions

(76) Inventor: Daniel John Devine, Slatington, PA (US)

Correspondence Address: Ryan, Mason & Lewis, LLP, Suite 205, 1300 Post Road, Fairfield, CT, 06824, US

(21) Appl. No.: 10/787,376

(22) Filed: Feb. 26, 2004

(51) Int. Cl. G06F 13/10

(52) U.S. Cl. 710/62

(57) ABSTRACT

A USB device controller is disclosed that provides excess processing resources for a peripheral device. The disclosed high speed communication controller controls communications between a host computer and at least one peripheral device. The disclosed communication controller includes a processor for controlling communications on a bus using one or more communication functions, wherein the processor performs at least one function for the peripheral device in addition to the one or more communication functions. Generally, the processor in the communication controller provides processing capacity for use by the peripheral device in addition to processing of the one or more communication functions. The high speed communications can conform, for example, to a USB standard, an IEEE 1394 standard or an IEEE 802.11 standard.

### FIELD OF THE INVENTION

The present invention relates generally to digital communications and, more particularly, to high speed interfaces between host computers and peripheral devices.

### BACKGROUND OF THE INVENTION

The Universal Serial Bus (USB) specification (downloadable from www.usb.org) allows a number of different peripheral devices to be easily connected to a computer. The USB specification defines a serial bus arrangement that supports the exchange of data between a host computer and one or more peripheral devices on a single interrupt request line. Generally, once a peripheral device is connected to a USB connector, the peripheral device can be used without requiring the user to perform any significant setup procedure or to load a driver associated with the peripheral device.

Each peripheral device includes a USB device controller that allows the peripheral device to communicate with the host computer over the USB bus. USB device controllers typically include a dedicated processor to perform USB functions, such as transmit, receive and interrupt functions. In addition, the peripheral devices typically include a primary microprocessor for performing the normal functions of the peripheral device, resulting in increased size and manufacturing costs and an inefficient use of processing resources. A need therefore exists for a USB device controller that shares processing resources with the primary peripheral processor.

### SUMMARY OF THE INVENTION

Generally, a USB device controller is disclosed that provides excess processing resources for a peripheral device. The disclosed high speed communication controller controls communications between a host computer and at least one peripheral device. The disclosed communication controller includes a processor for controlling communications on a bus using one or more communication functions, wherein the processor performs at least one function for the peripheral device in addition to the one or more communication functions. Generally, the processor in the communication controller provides processing capacity for use by the peripheral device in addition to processing of the one or more communication functions. The high speed communications can conform, for example, to a USB standard, an IEEE 1394 standard or an IEEE 802.11 standard.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram illustrating high speed communications over an exemplary USB bus between a host computer and a peripheral device, in accordance with conventional techniques;

FIG. 2 is a schematic block diagram illustrating high speed communications over an exemplary USB bus between a host computer and a peripheral device, in accordance with the present invention; and

FIG. 3 is a schematic block diagram of the ARM-based USB device controller of FIG. 2 incorporating features of the present invention.

### DETAILED DESCRIPTION

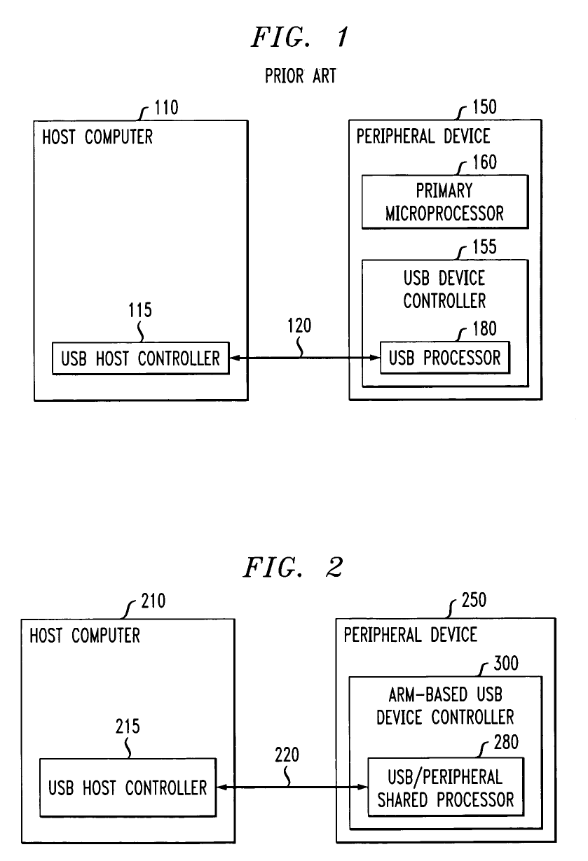

FIG. 1 is a schematic block diagram illustrating high speed communications over an exemplary USB bus 120 between a host computer 110 and a peripheral device 150. As shown in FIG. 1, the host computer 110 includes a USB host controller 115 for controlling communications on the USB bus 120. Similarly, the peripheral device 150 includes a USB device controller 155 for controlling communications on the USB bus 120. The USB device controller 155 includes a processor 180 for controlling the processing of USB functions, such as transmit, receive and interrupt functions. In addition, as previously indicated, the peripheral device 180 includes a primary microprocessor 160 for performing the normal functions of the peripheral device 180. The host computer 110 may be embodied, for example, as a personal computer or laptop. The peripheral device 180 may be embodied, for example, as a modem, camera, adapter, printer or scanner. It is noted that a given host computer 110 may communicate with a number of peripheral devices 180 over the same USB bus 120, in a known manner. While the present invention is illustrated in the context of an exemplary USB bus environment, the present invention applies to any high speed input/output (I/O) environment, including an IEEE 1394 environment or a wireless high speed input/output (I/O) environment in accordance with the IEEE 802.11 standard.

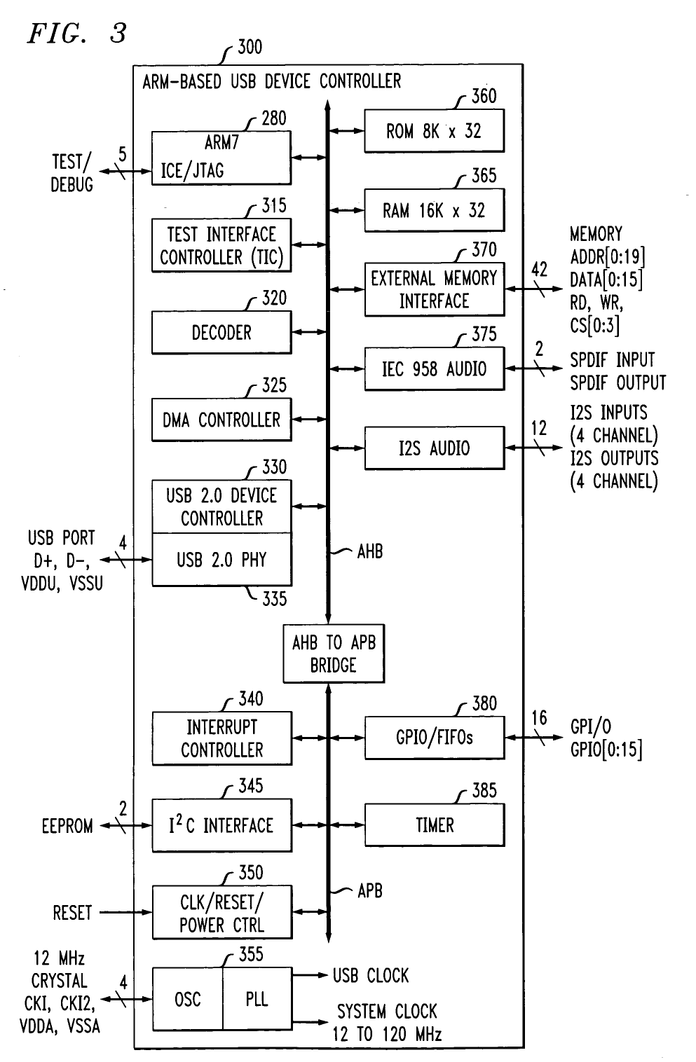

FIG. 2 is a schematic block diagram illustrating high speed communications over an exemplary USB bus 220 between a host computer 210 and a peripheral device 250, in accordance with the present invention. The host computer 210, host controller 215 and USB bus 220 may be embodied in a conventional manner. According to one aspect of the present invention the peripheral device 250 includes an ARM-based USB device controller 300, discussed further below in conjunction with FIG. 3. The ARM-based USB device controller 300 includes a USB/Peripheral shared processor 280 that provides sufficient processing resources to perform USB functions, such as transmit, receive and interrupt functions, and at least a portion of the normal functions of the peripheral device 180. In this manner, the USB/Peripheral shared processor 280 allows processing resources to be shared with by the ARM-based USB device controller 300 and the peripheral device 250. The USB/Peripheral shared processor 280 off-loads the existing peripheral processor 160 of conventional designs, such that the processing power of the processor 160 can be reduced or the processor 160 can be eliminated entirely from the architecture resulting in a reduced cost and smaller form factor.

The USB/Peripheral shared processor 280 provides additional MIPs (Million Instructions Per Second) over and above that required for fundamental USB 2.0 traffic processing. In one implementation, the USB/Peripheral shared processor 280 may be embodied as an ARM7TDMI processor core commercially available from Advanced RISC Machines Limited (ARM) (www.arm.com). The ARM-based USB device controller 300 interfaces with the USB host controller 215 on the upstream side of the USB peripheral 250, in a known manner. As discussed further below in conjunction with FIG. 3, the ARM-based USB device controller 300 also includes an external memory interface (EMI) so that other memory-mapped devices may be incorporated into the design of the USB peripheral 250.

FIG. 3 is a schematic block diagram of the ARM-based USB device controller 300 incorporating features of the present invention. As previously indicated, the ARM-based USB device controller 300 is based on an ARM7TDMS core and provides additional processing capacity to support one or more functions of a peripheral device, such as the peripheral device 250. The exemplary ARM-based USB device controller 300 employs an Arm Microcontroller Bus Architecture (AMBA) where an advanced high-performance bus (AHB) is used for the high-speed memories and peripherals and an advanced peripheral bus (APB) for communicating with lower speed peripheral devices. Among other features, the advanced high-performance bus employs single-clock synchronous logic (single active rising edge clock), maximizes high-performance operation by the ability to use the full clock cycle, and optimizes system performance by sharing resources between different bus masters, such as the ARM processor 280, DMA controllers 325 or secondary processors (not shown).

As shown in FIG. 3, the exemplary ARM processor 280 includes a number of interfaces for communicating with external devices. For example, a Test/Debug interface may be provided for testing and debugging of the ARM processor 280, discussed below. The Test/Debug interface may be, for example, a standard 5-wire JTAG (Joint Test Action Group) interface that is often used by the ARM development tools for loading and debugging software. This JTAG interface can also be used for loading production tests. A USB interface (USB Port) may be a two wire differential interface (D-plus and D-minus) plus dedicated V_{DD} and V_{SS} pins. An additional pin for an external precision resistor may also be provided. The ARM-based USB device controller 300 also includes an EEPROM interface 345 that may be a two wire Intelligent Interface Controller (I2C) bus. Typically, the serial EEPROM is used to store small amounts of configuration information such as identifiers and serial numbers. The ARM-based USB device controller 300 provides a Crystal interface to an external clock source, such as an external 30 MHz crystal. This Crystal interface may include two crystal connections (CKI, CKI2) as well as dedicated V_{DD} and V_{SS} pins. An internal PLL 355 generates the required higher-speed clocks for the USB and ARM cores.

A Modem Data Access Arrangements (DAA) interface provides pins to support a number of codec/DAA devices. The Data Access Arrangements (DAA) are generally required by semiconductor fax and modem chip sets to connect the fax, modem or voice circuit to the Public Switched Telephone Network (PSTN). A DAA_Select pin is connected internally to a General Purpose Input/Output (GPIO) signal and the setting of this pin is read by firmware to configure the ARM-based USB device controller 300 for the desired mode of operation. When the ARM-based USB device controller 300 is used as a simple device controller, an external processor connects to the General Purpose I/O interface in order to efficiently pass data over an 8-bit bus. In other applications, the port can be configured as general-purpose I/O's for connecting to external hardware.

As shown in FIG. 3, and discussed above, the exemplary ARM processor 280 includes an ARM processor core 280 that can run at clock speeds up to 80 MHz and from the on-chip memory will yield 40 MIPs of performance. As indicated above, a JTAG interface is provided for connecting to the ARM development tools.

The ARM-based USB device controller 300 also includes read only memory 360 and random access memory 365. An External Memory Interface 370 is a 16-bit wide memory bus with 24 address lines. There are four chip selects available in the exemplary embodiment to select external Flash ROM, RAM or other memory devices. The starting memory address and length for each device select strobe is programmable as are wait states. This allows the use of mixed on-chip and external memories.

A programmable timer is available to the ARM7 processor 2870 to enable, for example, the use of real-time operating systems. The timer is generally programmable in increments of the exemplary 30 MHz clock period.

The USB 2.0 PHY block 335 may be embodied in accordance with the USB 2.0 specification. The USB 2.0 Device Controller 330 receives signals from the PHY layer 335 and provides USB commands to the ARM processor 280. The USB 2.0 Device Controller 330 may be embodied using the USB 2.0 device controller from the Synopsis DesignWare library. A Programmable Interrupt Controller 340 consolidates the various interrupt sources from within the ARM-based USB device controller 300 and allows them to be independently enabled by the ARM core. An I²C Interface 345 may be a two-wire bi-directional serial bus that is capable of providing simple and efficient communication between devices. A single industry-standard EEPROM device can be interfaced to the ARM-based USB device controller 300 through the I²C block 345. The ARM-based USB device controller 300 may support a number of known I²C features.

An on-chip power-up reset generator 350 works in conjunction with an external RESET signal to control the internal reset of the device 300. An external 30 MHz crystal and internal (PHY) PLL's 480 Mhz output provide the clock source to the device. At power-up, the crystal interface is enabled and the PLL output is not used. The exemplary ARM7 core runs at the 30 MHz crystal rate and can boot from the on-chip ROM 360. The ARM7 clock can be programmed up to 80 MHz by switching to PHY PLL output in conjunction with a clock divider setting under software control.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks such as DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer readable code means is any mechanism for allowing a computer to read instructions and data, such as magnetic variations on a magnetic media or height variations on the surface of a compact disk, such as a DVD.

It is to be understood that the embodiments and variations shown and described herein are merely illustrative of the principles of this invention and that various modifications may be implemented by those skilled in the art without departing from the scope and spirit of the invention.

1. A controller for high speed communications between a host computer and at least one peripheral device, comprising:
a processor for controlling communications on a bus using one or more communication functions, wherein said processor performs at least one function for said peripheral device in addition to said one or more communication functions.

2. The controller of claim 1, wherein said processor is integrated with said controller.

3. The controller of claim 1, wherein said processor provides processing capacity for use by said peripheral device in addition to processing of said one or more communication functions.

4. The controller of claim 1, wherein said at least one peripheral device employs said processor to perform each of said functions of said at least one peripheral device.

5. The controller of claim 1, wherein said high speed communications conform to a USB standard.

6. The controller of claim 1, wherein said high speed communications conform to an IEEE 1394 standard.

7. The controller of claim 1, wherein said high speed communications conform to an IEEE 802.11 standard.

8. A method for controlling communications between a host computer and at least one peripheral device, comprising the step of:
executing one or more communication functions that control communications on a bus using a first processor, wherein said first processor also performs at least one function for said peripheral device in addition to said one or more communication functions.

9. The method of claim 8, wherein said first processor provides processing capacity for use by said peripheral device in addition to processing of said one or more communication functions.

10. The method of claim 8, wherein said at least one peripheral device employs said first processor to perform each of said functions of said at least one peripheral device.

11. The method of claim 8, wherein said high speed communications conform to a USB standard.

12. The method of claim 8, wherein said high speed communications conform to an IEEE 1394 standard.

13. The method of claim 8, wherein said high speed communications conform to an IEEE 802.11 standard.

14. An integrated circuit, comprising:
a controller for high speed communications between a host computer and at least one peripheral device, comprising:
a processor for controlling communications on a bus using one or more communication functions, wherein said processor performs at least one function for said peripheral device in addition to said one or more communication functions.

15. The integrated circuit of claim 14, wherein said processor is integrated with said controller.

16. The integrated circuit of claim 14, wherein said processor provides processing capacity for use by said peripheral device in addition to processing of said one or more communication functions.

17. The integrated circuit of claim 14, wherein said at least one peripheral device employs said processor to perform each of said functions of said at least one peripheral device.

18. The integrated circuit of claim 14, wherein said high speed communications conform to a USB standard.

19. The integrated circuit of claim 14, wherein said high speed communications conform to an IEEE 1394 standard.

20. The integrated circuit of claim 14, wherein said high speed communications conform to an IEEE 802.11 standard.
